(19) United States
(12) Patent Application Publication
(10) Pub. No.: US 2015/0198747 A1
(43) Pub. Date: Jul. 16, 2015

(54) GRAPHENE DISPLAY PROTECTION

(71) Applicant: Tyson York Winarski, Mountain View, CA (US)

(72) Inventor: Tyson York Winarski, Mountain View, CA (US)

(21) Appl. No.: 14/593,112

(22) Filed: Jan. 9, 2015

Related U.S. Application Data
(60) Provisional application No. 61/926,322, filed on Jan. 12, 2014.

(51) Int. Cl. G02B 1/14; G06F 1/16

(52) U.S. Cl. CPC G02B 1/14; G06F 1/16

(57) ABSTRACT

An electronic device is disclosed having a display with a viewing area. A hardcoat protective layer covers the display. The hardcoat protective layer is formed of an atomically contiguous sheet of graphene positioned over a matrix. The graphene may also be embedded on the surface of a matrix. The graphene may also be encapsulated within a matrix.

This application claims the benefit of U.S. Provisional Application No. 61/926,322 filed on Jan. 11, 2014.

### BACKGROUND

From large screen televisions to computer displays, tablets, mobile devices, kitchen appliances, automobile dashboards, and a whole host of additional applications, electronic displays are ubiquitous in modern technology. Electronic displays facilitate the indispensible transfer of visual information from electronic devices to users.

Once, Cathode-Ray-Tubes (CRT) displays were the sole means of displaying electronic video information. Today, a diverse ecosystem of technologies compete to provide the best visual image. Many displays provide only visual information. However, touchscreen displays allow users to physically interact directly with the display. A touchscreen is an electronic visual display that the user can control through simple or multi-touch gestures by touching the screen with one or more fingers. Some touchscreens can also detect objects such as a stylus or ordinary or specially coated gloves. The user can use the touchscreen to react to what is displayed and to control how it is displayed (for example by zooming the text size). The touchscreen enables the user to interact directly with what is displayed, rather than using a mouse, touchpad, or any other intermediate device (other than a stylus, which is optional for most modern touchscreens). Touchscreens are common in devices such as game consoles, all-in-one computers, tablet computers, and smartphones. They can also be attached to computers or, as terminals, to networks. Some touchscreen displays provide haptic feedback to the user, which is a tactile feedback that takes advantage of the sense of touch by applying forces, vibrations, or motions to the user. As such, these haptic feedback touchscreen displays can have the functionality of a touchscreen yet provide some physical feedback sensations to the user as the user would gain from touching a regular button, switch or knob.

One type of display is a Liquid Crystal Display (LCD). LCD displays utilize two sheets of polarizing material with a liquid crystal solution between them. An electric current passed through the liquid causes the crystals to align so that light cannot pass through them. Each crystal, therefore, is like a shutter, either allowing light to pass through or blocking the light.

The term liquid crystal is used to describe a substance in a state between liquid and solid but which exhibits the properties of both. Molecules in liquid crystals tend to arrange themselves until they all point in the same specific direction. This arrangement of molecules enables the medium to flow as a liquid. Depending on the temperature and particular nature of the substance, liquid crystals can exist in one of several distinct phases. Liquid crystals in a nematic phase, in which there is no spatial ordering of the molecules, for example, are used in LCD technology. One important feature of liquid crystals is the fact that an electrical current affects them. A particular sort of nematic liquid crystal, called twisted nematics (TN), is naturally twisted. Applying an electric current to these liquid crystals will untwist them to varying degrees, depending on the current's voltage. LCDs use these liquid crystals because they react predictably to electric current in such a way as to control the passage of light.

Liquid crystal materials emit no light of their own. Small and inexpensive LCDs are often reflective, which means if they are to display anything, they must reflect the light from external light sources. The numbers in an LCD watch appear where the small electrodes charge the liquid crystals and make the crystals untwist so that the light is not transmitting through the polarized film. Backlit LCD displays are lit with built-in fluorescent tubes above, beside and sometimes behind the LCD. A white diffusion panel behind the LCD redirects and scatters the light evenly to ensure a uniform display. On its way through liquid crystal layers, filters and electrode layers, more than half of this light is lost.

Monochrome LCD images usually appear as blue or dark gray images on top of a grayish-white background. Color LCD displays use two basic techniques for producing color: Passive Matrix and Active Matrix. Passive Matrix LCDs use a simple grid to supply the charge to particular pixels on the display. Passive Matrix LCDs start with two glass layers called the substrates. One substrate is given rows and the other is given the columns, made from a transparent conductive material. The liquid crystal material is sandwiched between the two glass substrates, and the polarizing film is added to the outer side of each display. To turn on a pixel, the integrated circuit sends a charge down the correct column of one substrate and a ground activated on the correct row of the other. The row and column intersect at a designated pixel, and that delivers the voltage to untwist the liquid crystals at that pixel. As the current required to brighten a pixel increases (for higher brightness displays) and, as the display gets larger, this process becomes more difficult since higher currents have to flow down the control lines. Also, the controlling current must be present whenever the pixel is required to light up. As a result, passive matrix displays tend to be used mainly in applications where inexpensive, simple displays are required. Direct addressing is a technique mostly used in Passive Matrix Displays in which there is a direct connection to every element in the display, which provides direct control over the pixels.

Active matrix displays belong to type of flat-panel display in which the screen is refreshed more frequently than in conventional passive-matrix displays, and which uses individual transistors to control the charges on each cell in the liquid-crystal layer. The most common type of active-matrix display is based on Thin-Film Transistor (TFT) technology. The two terms, active matrix and TFT, are often used interchangeably. Whereas a passive matrix display uses a simple conductive grid to deliver current to the liquid crystals in the target area, an active matrix display uses a grid of transistors with the ability to hold a charge for a limited period of time, much like a capacitor. Because of the switching action of transistors, only the desired pixel receives a charge, improving image quality over a passive matrix. Because of the thin film transistor's ability to hold a charge, the pixel remains active until the next refresh.

Another type of display utilizes Organic Light Emitting Diode (OLED) technology based on substances that emit red, green, blue or white light. Without any other source of illumination, OLED materials present bright, clear video and images that are easy to see at almost any angle. OLED displays stack up several thin layers of materials. The displays comprise of dielectric light-emitting phosphor layers sandwiched between two conductive surfaces. During manufacturing, multiple organic layers are laminated onto the stripes of optically transparent inorganic electrodes. The organic layers comprise of an electron transport layer (ETL) and a hole transport layer (HTL). The layers operate on the attraction between positively and negatively charged particles. When voltage is applied, one layer becomes negatively charged relative to another transparent layer. As energy passes from the negatively charged (cathode or ETL) layer to the other (anode or HTL) layer, it stimulates organic material between the two, which emits light visible through the outermost layer of glass. Doping or enhancing organic material helps control the brightness and color of light.

Active Matrix (AM) and Passive Matrix (PM) screens are two fundamental types of OLED display assembly. Each type lends itself to different applications. AM OLED displays stack cathode, organic, and anode layers on top of another layer—or substrate—that contains circuitry. The pixels are defined by the deposition of the organic material in a continuous, discrete “dot” pattern. Each pixel is activated directly: A corresponding circuit delivers voltage to the cathode and anode materials, stimulating the middle organic layer. AM OLED pixels turn on and off more than three times faster than the speed of conventional motion picture film, making these displays ideal for fluid, full-motion video. The substrate—low-temperature polysilicon (LTPS) technology—transmits electrical current extremely efficiently, and its integrated circuitry cuts down AM OLED displays' weight and cost. PM OLED displays stack layers in a linear pattern much like a grid, with “columns” of organic and cathode materials superimposed on “rows” of anode material. Each intersection or pixel contains all three substances. External circuitry controls the electrical current passing through the anode “rows” and cathode “columns,” stimulating the organic layer within each pixel. As pixels turn on and off in sequence, pictures form on the screen. PM OLED display function and configuration are well-suited for text and icon displays in dashboard and audio equipment. Comparable to semiconductors in design, PM OLED displays are easily, cost effectively manufactured with today's production techniques.

A further type of display is a Ferro Liquid Display, or Ferro-electric Liquid Display (FLD) or Ferro Fluid Display (FFD), which is a display technology based on the ferroelectric properties of certain liquids. Not all such fluids are crystal but they are generically referred to as Ferro Liquid Crystal Displays (FLCD). These fluids have bistable properties that can be switched with a magnetic field. The switching time is much shorter than that of a typical LCD that twist/untwist due to magnetic rather than electric interactions.

Another type of display is a Light Emitting Diode (LED) display that uses an array of light emitting diodes to produce an image. There are two types of LED panels: conventional (using discrete LEDs) and surface-mounted device (SMD) panels. Most outdoor screens and some indoor screens are built around discrete LEDs, also known as individually mounted LEDs. A cluster of red, green, and blue diodes is driven together to form a full-color pixel, usually square in shape. These pixels are spaced evenly apart and are measured from center to center for absolute pixel resolution. Most indoor screens on the market are built using SMD technology. An SMD pixel consists of red, green, and blue diodes mounted in a single package, which is then mounted on the driver PC board. The individual diodes are smaller than a pinhead and are set very close together. The difference is that the maximum viewing distance is reduced by 25% from the discrete diode screen with the same resolution. LEDs may be used in combination with LCDs. A LED-backlit LCD display is a flat panel display, which uses LED backlighting instead of the cold cathode fluorescent (CCFL) backlighting used by most other LCDs.

One common problem for displays is surface abrasion that scratches and damages the screen. Scratched on the screen can greatly impact the appeal of an image and quality of a display. The occurrence of surface abrasion is particularly acute for portable electronic devices that include displays such as mobile phones and tablets. In addition to surface abrasion, the screens on displays may get their surfaces chipped and cracked as these devices are utilized. It is therefore desirable to develop electronic displays that have screens with increased ability to resist surface abrasion, chips, cracking, and general wear and tare to ensure display of a high quality image to the user.

### SUMMARY

The present invention is directed toward an electronic device having a display having a viewing area. A hardcoat protective layer covers the display. In a preferred embodiment, the hardcoat protective layer is formed of an atomically contiguous sheet of graphene positioned over a matrix. The atomically contiguous sheet of graphene has a surface area at least as large as the viewing area of said display. The atomically contiguous sheet of graphene may have a surface area larger than the viewing area of the display. The matrix material may be a glass, a polymer, or an adhesive, for example. The atomically contiguous sheet of graphene may cover the entire area of the view area of said display, thereby providing wear protection to said display. The atomically contiguous sheet of graphene may be formed of a monolayer of graphene. The atomically contiguous sheet of graphene may be formed of multiple layers of graphene. The display covered by the protective layer may be one of the following exemplary and non-limiting displays: a touch screen display, a Thin Film Transistor (TFT) display, a Liquid Crystal (LCD) display, a Ferro-Electric Liquid Display (FLD), Ferro-Liquid Crystal Displays (FLCD), a Light Emitting Diode (LED) Display, or an Organic Light Emitting Diode (OLED) Display.

In another embodiment, an electronic device having a display with a viewing area is disclosed. A hardcoat protective layer covers this display. In this alternative embodiment, the hardcoat protective layer includes an atomically contiguous sheet of graphene embedded on the surface a matrix. The atomically contiguous sheet of graphene has an area at least as large as the viewing area of the display. The hardcoat protective layer may be flexible. The matrix is formed of a material such as a glass, a polymer, or an adhesive. The atomically contiguous sheet of graphene may cover the entire area of the view area of the display, thereby providing wear protection to the display. The atomically contiguous sheet of graphene may be formed of a monolayer of graphene. The atomically contiguous sheet of graphene may be formed of multiple layers of graphene. The graphene embedded protective layer may be used with one of the following exemplary and non-limiting displays: a Thin Film Transistor (TFT) display, a Liquid Crystal (LCD) display, a Ferro-Electric Liquid Display (FLD), Ferro-Liquid Crystal Displays (FLCD), a Light Emitting Diode (LED) Display, and an Organic Light Emitting Diode (OLED) Display.

In a further embodiment, an electronic device is disclosed that includes a display having a viewing area. A hardcoat protective layer covers the display. said hardcoat protective layer comprising a plurality of polygonal-shaped sheets of graphene arranged in a tile-pattern to form a contiguous sheet of graphene, said contiguous sheet of graphene being over a matrix, said contiguous sheet of graphene having an area at least as large as the viewing area of said display. The polygonal-shaped sheets of graphene may be arranged in a non-overlapping tile-pattern.

Alternatively, the polygonal-shaped sheets of graphene may be arranged in an overlapping tile-pattern. The matrix material can be glass, a polymer, or an adhesive. The contiguous sheet of graphene covers the entire area of the view area of the display, thereby providing wear protection to said display. The graphene embedded protective layer may be used with one of the following exemplary and non-limiting displays: a Thin Film Transistor (TFT) display, a Liquid Crystal (LCD) display, a Ferro-Electric Liquid Display (FLD), Ferro-Liquid Crystal Displays (FLCD), a Light Emitting Diode (LED) Display, and an Organic Light Emitting Diode (OLED) Display.

Further aspects of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings, wherein:

FIG. 1 illustrates a cross-sectional view A-A of an electronic device having a display covered by a hardcoat protective layer that includes a sheet of graphene placed over a matrix;

FIG. 2 illustrates a top view of an electronic device having a display covered by a hardcoat protective layer that includes a sheet of graphene placed over a matrix;

FIG. 3 illustrates a perspective view of hardcoat protective layer that has a sheet of graphene placed over a matrix;

FIG. 4 illustrates a cross-sectional view B-B of an electronic device having a display covered by a hardcoat protective layer that includes a sheet of graphene embedded on the surface a matrix;

FIG. 5 illustrates a top view of an electronic device having a display covered by a hardcoat protective layer that includes a sheet of graphene embedded on the surface a matrix;

FIG. 6 illustrates a perspective view of hardcoat protective layer that has a sheet of graphene embedded on the surface of a matrix;

FIG. 7 illustrates a cross-sectional view A-A of an electronic device having a display covered by a hardcoat protective layer that includes a sheet of graphene encapsulated within a matrix;

FIG. 8 illustrates a top view of an electronic device having a display covered by a hardcoat protective layer that includes a sheet of graphene encapsulated within a matrix;

FIG. 9 illustrates a perspective view of hardcoat protective layer that has a sheet of graphene encapsulated within a matrix;

FIG. 10 diagrammatically depicts an atomically contiguous sheet of graphene;

FIG. 11 illustrates a contiguous sheet of graphene formed of multiple polygonal shaped graphene sheets that are positioned adjacent to each other in a non-overlapping tiled pattern;

FIG. 12 illustrates a contiguous sheet of graphene formed of multiple polygonal shaped graphene sheets that are positioned in an overlapping tiled pattern; and

FIG. 13 illustrates a flow chart depicting a method of placing a graphene sheet over a matrix through a Chemical Vapor Deposition (CVD) process.

### DETAILED DESCRIPTION

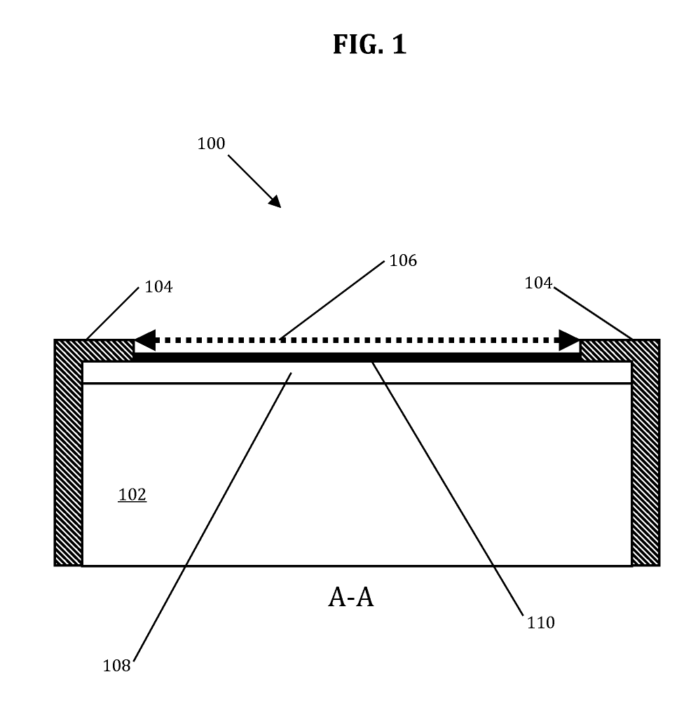

While the invention has been shown and described with reference to a particular embodiment thereof, it will be understood to those skilled in the art, that various changes in form and details may be made therein without departing from the spirit and scope of the invention. FIG. 1 illustrates a cross-sectional view A-A of an electronic device 100 having a display 102 covered by a hardcoat protective layer that includes a sheet of graphene 110 placed over a matrix 108. Electronic device 100 includes a display 102 that emits light. Display 102 can be any type of light emitting display. Exemplary and non-limiting types of displays include a touch screen display, a Thin Film Transistor (TFT) display, a Liquid Crystal (LCD) display, a Ferro-Electric Liquid Display (FLD), Ferro-Liquid Crystal Displays (FLCD), a Light Emitting Diode (LED) Display, a TFT-LCD display, and an Organic Light Emitting Diode (OLED) Display. Electronic device 100 may be rigid or flexible. A variety of flexible displays 102, such as OLED displays, are known. Display 102 may be supported by a frame 104. Examples of frames 104 include, but are not limited to, the external case of a mobile device, the external case of a mobile phone or tablet, the external case of a flat screen television or computer monitor. Electronic device has a viewing area 106. Viewing area 106 is the region of the display 102 that is visible to a user. In this exemplary drawing, viewing area 106 is defined by the border of frame 104 covering display 102. A matrix 108 is placed over display 102. Matrix 108 may be made of any hard or flexible transparent material. Exemplary transparent materials include glass, a polymer, resin, or an adhesive.

An atomically contiguous sheet of graphene 110 is placed over matrix 108. Atomically contiguous sheet of graphene 110 and matrix 108 form a protective hardcoat layer that protects electronic device 100 from chips, scratches and other mechanical damage. Atomically contiguous sheet of graphene 110 functions has a barrier to the ill effects of mechanical abrasion, thereby protecting matrix 108 from scratches, chips, and wear and tear due to use of electronic device 100. Graphene may be described as a flat monolayer of carbon atoms that are tightly packed into a two-dimensional (2D) honeycomb lattice. The carbon-carbon bond length in graphene is about 0.142 nanometers. The observed 97.7% optical transparency of graphene has been linked to the value of the fine structure constant by using results for non-interacting Dirac fermions. Grahpene is a hard material that is 97.7% optically transparent. Thus, layers of graphene near or on the exterior side of an electronic display provides wear protection to the display from mechanical abrasion and scratches while allowing light to pass through the graphene layers from the display to the user.

One exemplary method of fabricating an atomically contiguous sheet of graphene 110 over a glass (silica) matrix 108 is through Chemical Vapor Deposition (CVD). Silica has a melting point of 1600° C. CVD deposition of graphene is a process that occurs at 1000° C. Thus, CVD deposition of graphene 110 occurs on silica matrix 108 without any morphological changes in silica matrix 108. While discussed with respect to silica, it is contemplated that the CVD deposition of graphene 110 may be performed on any optic glass matrix 108 with a sufficiently high melting point to permit CVD deposition of graphene without morphological changes in matrix 108.

In order to facilitate the growth of graphene 110 on silica matrix 108, silica matrix 108 may be coated with a sacrificial layer of copper. Electron-beam evaporation is used to deposit copper (Cu) film onto silica matrix 108. Copper film functions as a sacrificial layer that de-wets and evaporates from silica matrix 108 during the CVD process. Copper covered silica matrix 108 is placed within a CVD chamber and heated to 1000° C. CVD of graphene is performed silica matrix 108 with durations varying from 15 min up to 7 h at 1000° C. Given the fact that that the melting temperature of the copper is −1084° C., along with the high temperature during the growth of −1000° C., and the low pressure in the chamber, 100-500 mTorr, the copper layer de-wets and evaporates during the CVD process. As such, the copper layer functions as a sacrificial layer. The length of time of the CVD graphene deposition process varies the thickness of the graphene layer 110 from a monolayer to multiple layers of graphene. The culmination of this CVD process is a atomically contiguous sheet of graphene 110 is placed over matrix 108. CVD growth of graphene directly on silica is described in the following reference, hereby incorporated by reference: Ariel Ismach, Clara Druzgalski, Samuel Penwell, Adam Schwartzberg, Maxwell Zheng, Ali Javey, Jeffrey Bokor, and Yuegang Zhang, Direct Chemical Vapor Deposition of Graphene on Dielectric Surfaces, Nano Lett. 2010, 10, 1542-1548, American Chemical Society, Apr. 2, 2010.

Alternatively, an atomically contiguous sheet of graphene 110 may be placed over matrix 108 through the use of an exfoliated sheet of graphene and adhesives. The ability to exfoliate 4-inch diameter contiguous sheets of graphene is presently demonstrated. 4-inch diameter contiguous sheets of graphene are created through a double exfoliation process. The first exfoliation separates graphene from a silicon carbide (SiC) substrate by using a stressed nickel layer. Once this step is completed, a second exfoliation is performed that removes any graphene in excess of a single-layer by using a thin gold layer—thus leaving only single-layer, single-oriented graphene. This 4-inch diameter contiguous sheet of graphene can be laser cut into a desirable shape in order to fit the viewing area 106 of electronic device 100. Once a desirable atomically contiguous sheet of graphene 110 is formed, it may be secured to matrix 108 through the use of an adhesive. Exemplary adhesives include, but are not limited to, cyanoacrylates, such as methyl-2-cyanoacrylate and ethyl-2-cyanoacrylate. Any adhesive capable of bonding a graphene sheet 110 to matrix 108 is contemplated. While the adhesive is in a liquid form, one or more sheets of graphene may be placed onto matrix 108. Once the one or more sheets of graphene are placed into matrix 108, the liquid adhesive may then be cured. Graphene sheet 110 may be formed of a single layer of graphene, or multiple layers of graphene. Note in FIG. 1 that atomically contiguous sheet of graphene 110 has a size that matches the size of viewing area 106. It is contemplated that atomically contiguous sheet of graphene 110 may have a size that is larger than viewing area 106.

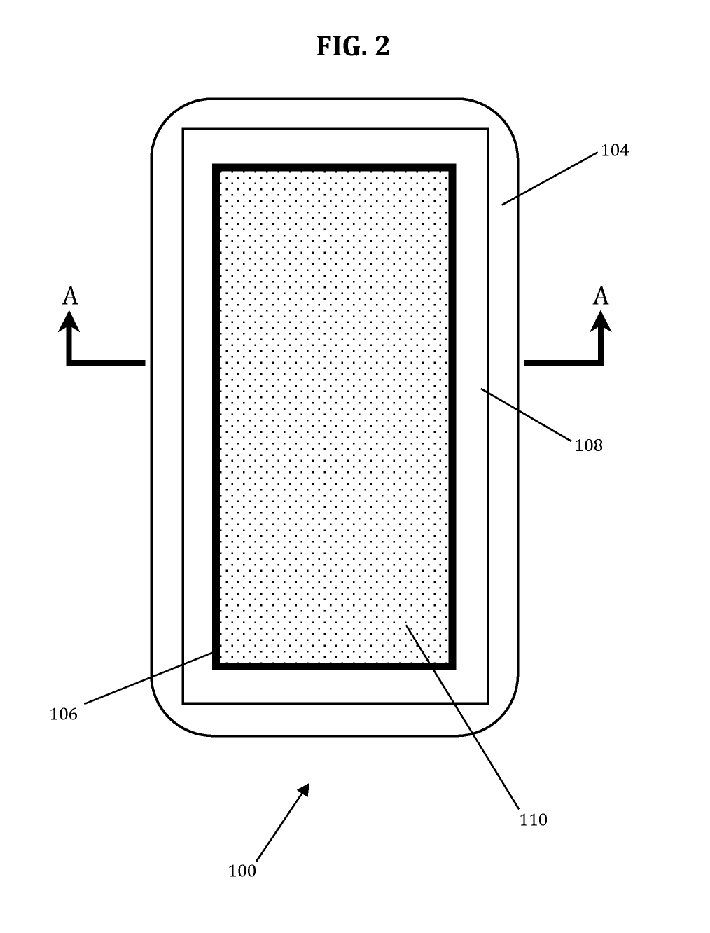

FIG. 2 illustrates a top view of an electronic device 100 having a display covered by a hardcoat protective layer that includes a sheet of graphene 110 placed over a matrix 108. In FIG. 2, electronic device 100 has a generic configuration of a mobile device such as a mobile phone or a tablet. Electronic device 100 includes an external frame or case 104. External case 104 may be formed of a plastic, metal, or other durable material. External case 104 may be rigid. Alternatively, external case 104 may be flexible to enable a flexible display 102. Box 106 depicts the view area 106 of electronic device 100. Within viewing area 106 is graphene sheet 110. Graphene sheet 110 provides durable wear protection to electronic device 100 to prevent mechanical abrasion defects from appearing in viewing area 106 such as scratches, chips, or cracks in the screen of display 102. Note that the sectional view A-A of device 100 illustrated in FIG. 1 is taken along section A-A shown in FIG. 2. In this illustration, it is contemplated that matrix 108 may be larger than viewing area 106. It is contemplated that matrix 108 may have the same size as viewing area 106 in an alternate embodiment.

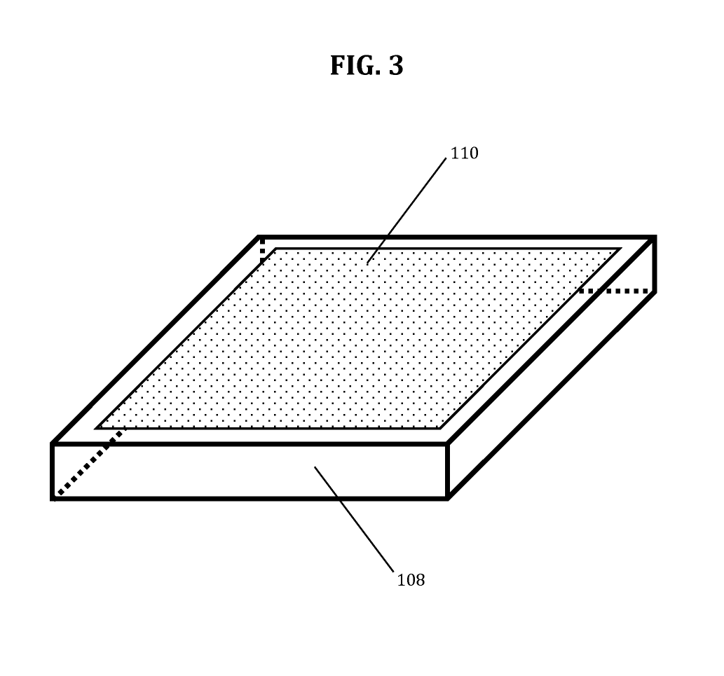

FIG. 3 illustrates a perspective view of the hardcoat protective layer that has a sheet of graphene 110 placed over a matrix 108. In this embodiment, sheet of graphene 110 is an atomically contiguous sheet of graphene. Having an atomically contiguous sheet of graphene 110 is highly desirable due to the high strength of graphene. An atomically contiguous sheet of graphene 110 provides superior wear protection to matrix 108 over composite materials made of graphene flakes held together with a binder. Composite materials made of graphene flakes held together with a binder are far more susceptible to scratches and other forms of mechanical abrasion.

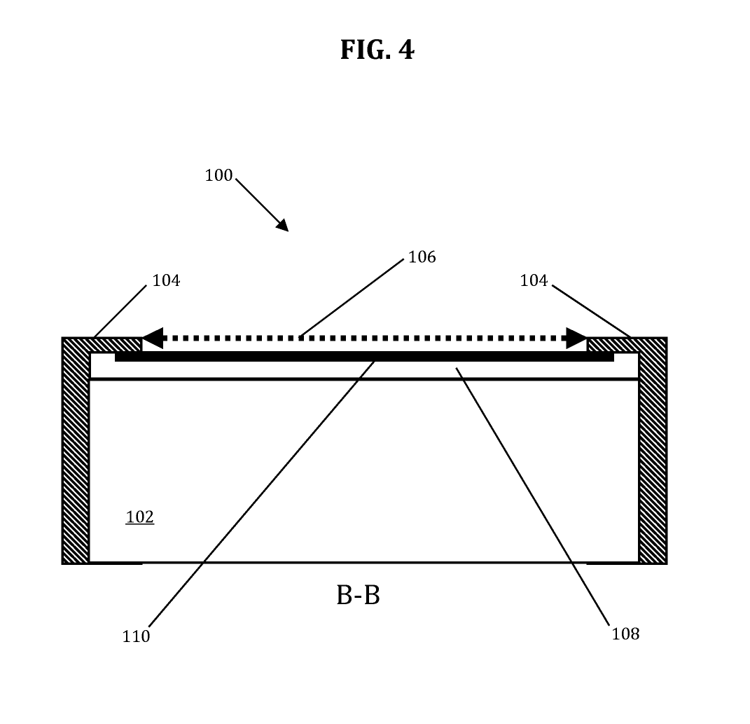

FIG. 4 illustrates a cross-sectional view B-B of an electronic device 100 having a display 102 covered by a hardcoat protective layer that includes a sheet of graphene 110 embedded on the surface of a matrix 108. In this embodiment, graphene layer 110 is embedded in matrix layer 108. One method of embedding graphene layer 110 in matrix layer 108 is through the use of flash-heating with a laser or through an infrared radiation pulse. Materials that are susceptible to softening by heat include, but are not limited to polymers, resins, glass, and other materials. Once matrix 108 is flash-heated, a sheet of graphene 110 is pressed into matrix 108. Sheet of graphene 110 may be acquired through the exfoliation process described above. Alternatively, a resin may be spin coated on matrix 108 in a liquid form. While in liquid form, a graphene sheet 110 may be placed within the resin. Then the resin may be hardened, such as for example by UV light in conjunction with a UV curable resin, thereby producing a graphene sheet embedded within a matrix 108. Note in this exemplary embodiment graphene layer 110 is larger than viewing area 106. It may prove desirable to have graphene sheet 110 larger than viewing area 106 to prevent mechanical abrasion at the boundary of viewing area 106.

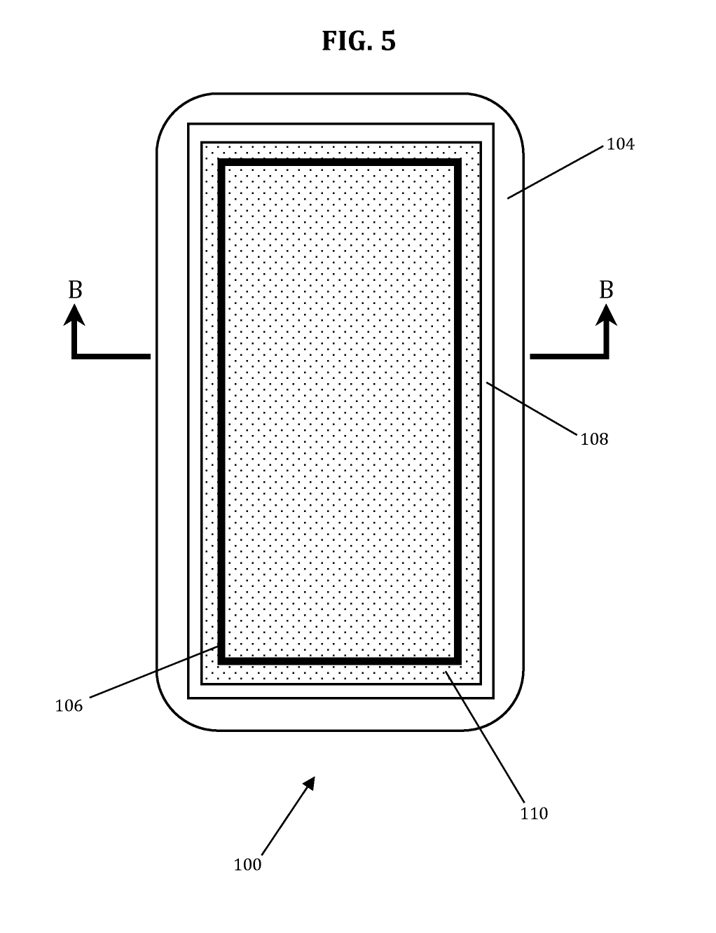

FIG. 5 illustrates a top view of an electronic device 100 having a display 102 covered by a hardcoat protective layer that includes a sheet of graphene 110 embedded on the surface a matrix 108. Graphene layer 110, which is atomically contiguous in contrast to composite materials made of flakes of graphene held together with a binder, is larger than viewing area 106. Note that the cross sectional view B-B of electronic device 100 shown in FIG. 4 is taken along section B-B shown in FIG. 5. In this figure, electronic device 100 has the configuration of a generic portable device such as a mobile phone or a tablet. While shown having an area larger than viewing area 106, it is contemplated the graphene sheet 110 may have an area that is the same as viewing area 106.

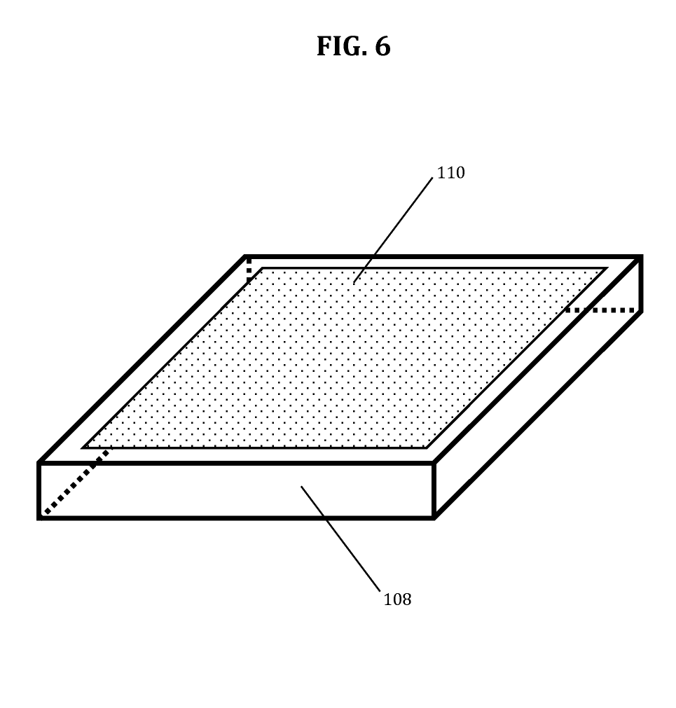

FIG. 6 illustrates a perspective view of hardcoat protective layer that has a sheet of graphene 110 embedded on the surface a matrix 108. Having an atomically contiguous sheet of graphene 110 is highly desirable due to the high strength of graphene. An atomically contiguous sheet of graphene 110 provides superior wear protection to matrix 108 over composite materials made of graphene flakes held together with a binder. Composite materials made of graphene flakes held together with a binder are far more susceptible to scratches and other forms of mechanical abrasion.

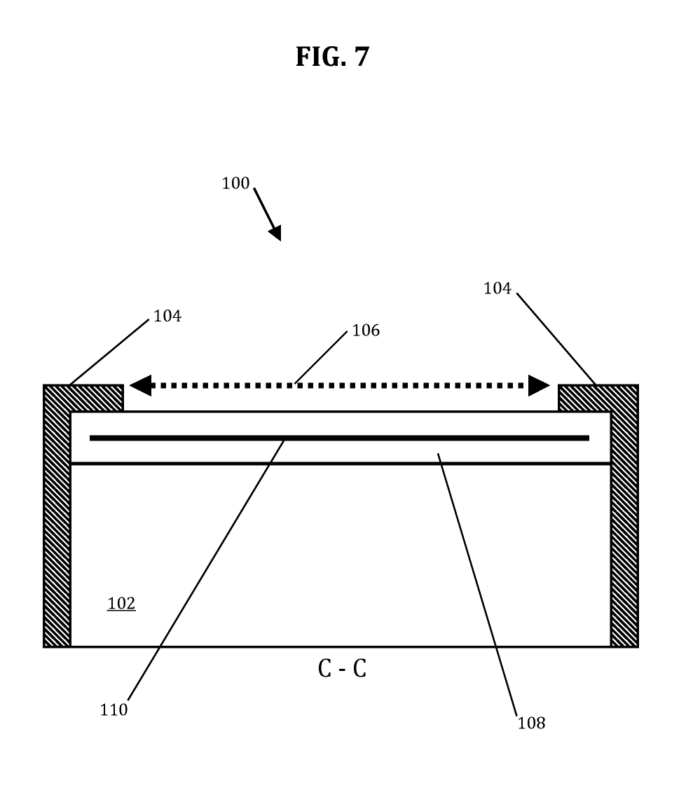

FIG. 7 illustrates a cross-sectional view A-A of an electronic device 100 having a display 102 covered by a hardcoat protective layer that includes a sheet of graphene 110 encapsulated within matrix 108. Electronic device 100 has a case or frame 104 that supports display 102. Display 102 has a viewing area or screen 106 through which a user sees visual information emitted from display 102. Display 102 is covered by a hardcoat protective layer made of an atomically contiguous sheet of graphene 110 encapsulated within a matrix 108. In this embodiment, graphene sheet 110 is completely encapsulated within matrix 108. This encapsulation may be achieved for example, by placing an exfoliated sheet of graphene 110 onto a substrate covered with a spin-coated liquid resin. Once this initial layer of resin is cured thereby binding graphene layer 110 to the resin, an additional layer of liquid resin could be spin-coated onto the graphene and subsequently hardened. Note in this embodiment that graphene sheet 110 has an area that is larger than viewing area 106. It is contemplated that graphene sheet 110 may have an area that is the same as viewing area 106.

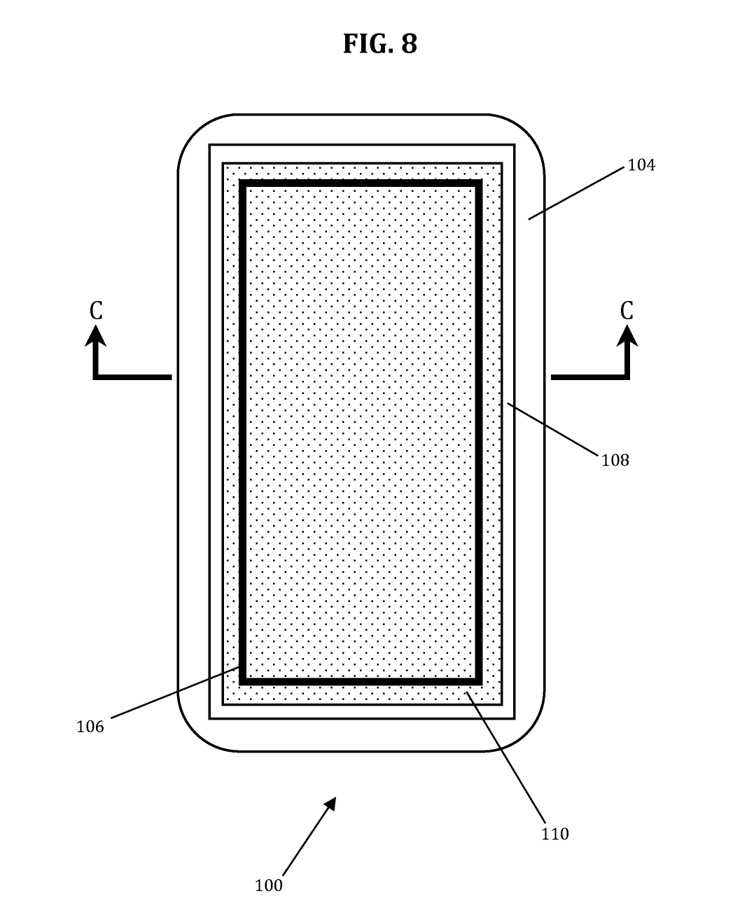

FIG. 8 illustrates a top view of an electronic device 100 having a display covered by a hardcoat protective layer that includes a sheet of graphene 110 encapsulated within a matrix 108. In this embodiment, graphene sheet 110 has an area that is larger than viewing area 106. It is contemplated that graphene sheet 110 may have an area that is the same as viewing area 106. As graphene layer 110 is encapsulated within matrix 108, matrix 108 has an area larger than graphene sheet 110.

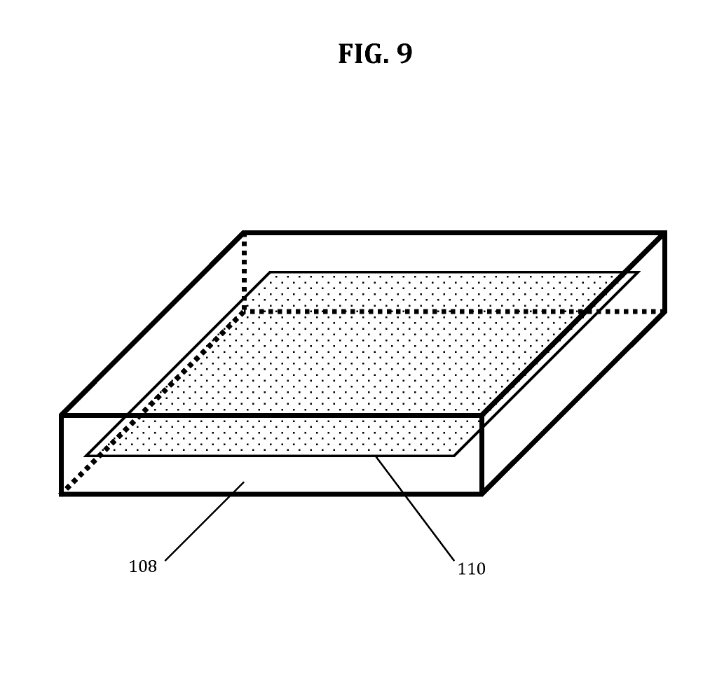

FIG. 9 illustrates a perspective view of hardcoat protective layer that has a sheet of graphene 110 encapsulated within a matrix 108. Graphene sheet 110 is atomically contiguous and surrounded on all sides by contiguous matrix 108.

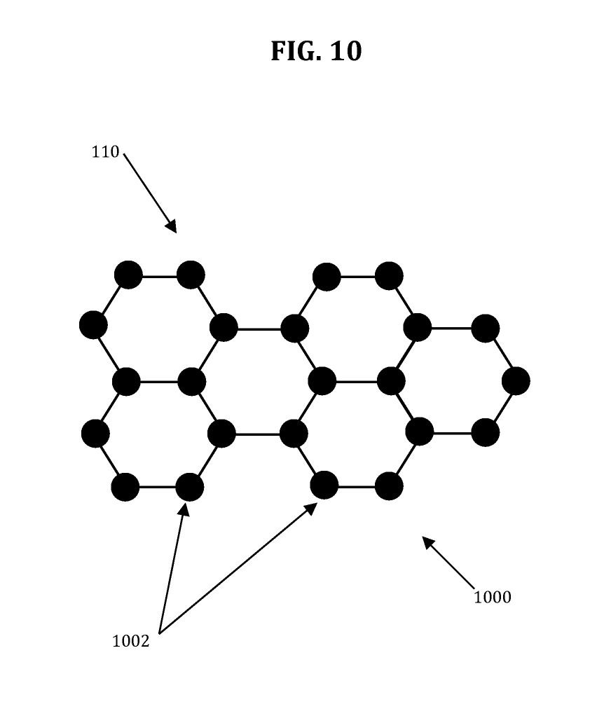

FIG. 10 diagrammatically depicts an atomically contiguous sheet of graphene 110. Graphene sheet, in this figure, is a contiguous graphene lattice 100. Graphene lattice 100, also referred to as a sheet of graphene 100, is a flat monolayer of carbon atoms 102 that are tightly packed into a two-dimensional lattice, thereby forming a sheet of graphene. Graphene lattice 100 is 97.7% optically transparent. Thus, light emitted from display 102 can pass through graphene sheet 110 for viewing by a user. Graphene lattice 100 is an extremely strong material due to the covalent carbon-carbon bonds. It is desirable to utilize graphene lattices 100 that are defect free as the presence of defects reduces the strength of graphene lattice 100. The intrinsic strength of a defect free sheet of graphene 100 is 42 Nm⁻¹, making it one of the strongest materials known. The strength of graphene is comparable to the hardness of diamonds.

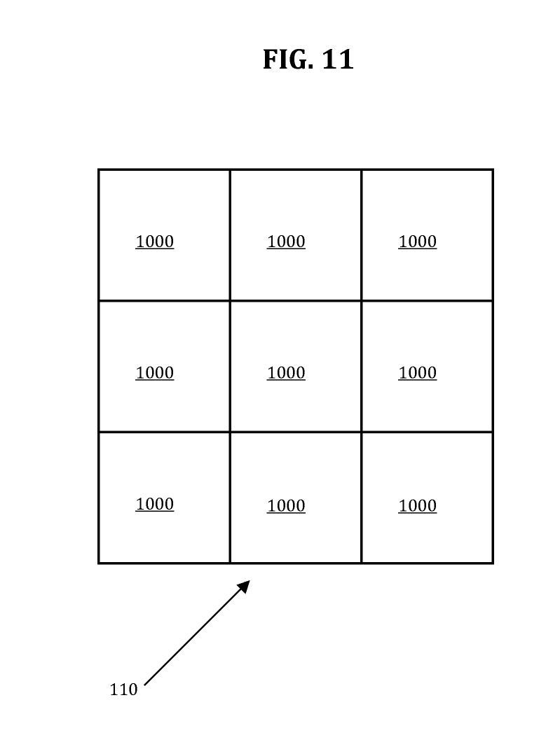

FIG. 11 illustrates a contiguous sheet of graphene 110 formed of multiple polygonal shaped graphene sheets 1000 that are positioned adjacent to each other in a non-overlapping tiled pattern. In order provide hardcoat protective layers for large displays utilizing exfoliated graphene sheets 1000, it is desirable to form polygonal shapes out of the exfoliated sheets 1000 such has squares, rectangles, hexagons, or the like. These graphene sheets 1000 can then form a contiguous layer of graphene 110 by placing them in a non-overlapping tiled pattern as shown in FIG. 11 where the edges of graphene sheets 1000 abut each other. This contiguous sheet of graphene 110, made up of multiple atomically contiguous sheets of graphene 1000 arranged in a non-overlapping tile pattern, can then be secured to matrix 108 through the use of an adhesive, a binder, or a flash-heating process for example.

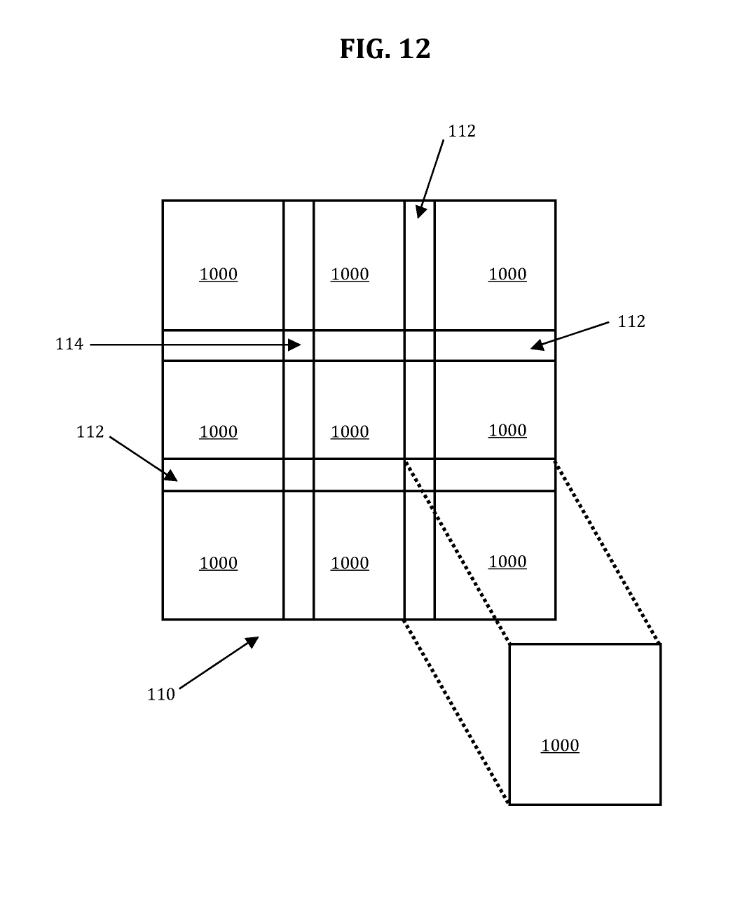

FIG. 12 illustrates a contiguous sheet of graphene 110 formed of multiple polygonal shaped graphene sheets 1000 that are positioned in an overlapping tiled pattern. In this exemplary embodiment, the exfoliated sheets of graphene 1000 are placed such that edges 112 of the atomically contiguous sheets of graphene 1000 overlap each other. Regions 114 have multiple sheets of graphene overlapping each other. While shown using square shaped exfoliated graphene sheets, it is contemplated that any polygonal shaped graphene sheet 1000 may be used to form an overlapping tile pattern. This contiguous sheet of graphene 110, made up of multiple atomically contiguous sheets of graphene 1000 arranged in a overlapping tile pattern, can then be secured to matrix 108 through the use of an adhesive, a binder, or a flash-heating process for example.

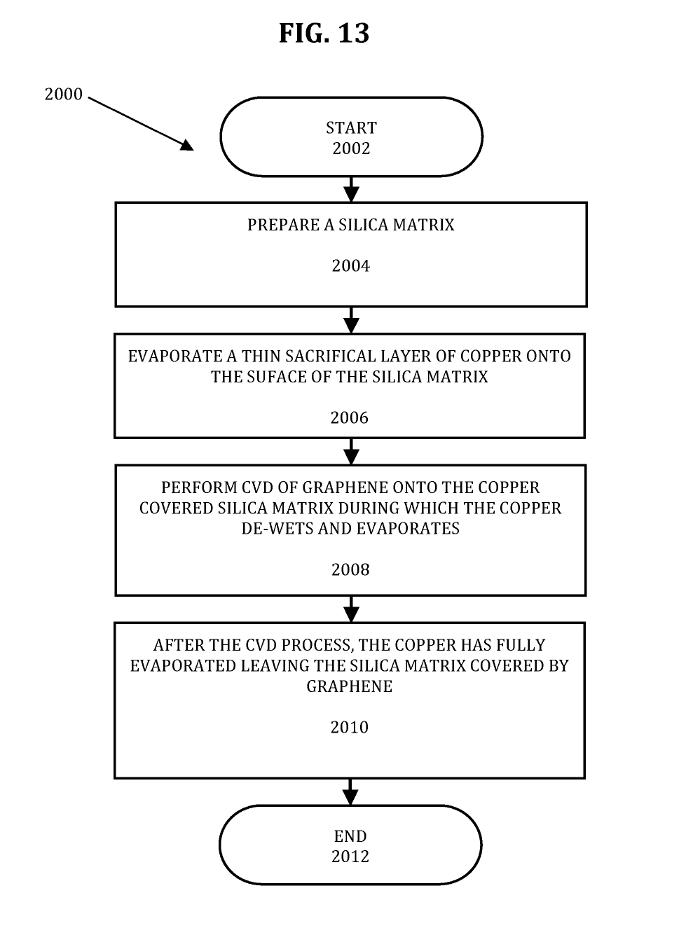

FIG. 13 illustrates a flow chart 2000 depicting a method of placing a graphene sheet 110 over a silica matrix 108 through a Chemical Vapor Deposition (CVD) process. The process begins with START in step 2002. In step 2004, a silica matrix 108, shown in FIG. 1 is prepared. Silica matrix is utilized as the surface upon which graphene sheet 110 is grown by Chemical Vapor Deposition (CVD). In step 2006, a sacrificial copper film is evaporated onto the silica matrix 108 as shown in FIG. 1. An electron-beam evaporation process is used to deposit the copper film onto the silica matrix 108.

In step 2008, silica matrix 108 having the sacrificial copper layer is inserted into a CVD chamber. Silica matrix 108 is heated to 1000° C. CVD of graphene is the performed on silica matrix 108 with durations varying from 15 min up to 7 h at 1000° C. Given the fact that that the melting temperature of the copper is ˜1084° C., along with the high temperature during the growth of ˜1000° C., and the low pressure in the chamber, 100-500 mTorr, the copper film de-wets and evaporates during the CVD process. Ethylene (C₂H₄) or CH₄ is introduced into the CVD chamber as the carbon containing precursor, in addition to the H₂/Ar flow. The precursor feeding time, typically in the order of a few to tens of seconds, determines the number of layers of graphene grown. The sample may then be cooled to room temperature within 5 min in a flow of 133 sccm Ar at 20 Torr chamber pressure. Silica matrix 108 is resilient to morphological changes at ˜1000° C. required for the CVD growth of high-quality graphene due to the high melting point of silica of 1600° C. During the CVD deposition process, the sacrificial copper layer de-wets and evaporates. During this CVD process, the sacrificial copper layer de-wets and evaporates exposing silica matrix 108 directly to graphene layer 110.

In step 2010, the CVD process is completed in which the sacrificial copper layer has fully evaporated leaving one or more layers of graphene deposited onto silica matrix 108. Utilization of silica matrix 108 results in the synthesis of graphene sheets 110 on silica matrix 108. The number of graphene sheets is determined by the growth time. As a consequence of this process 2000, a silica matrix 108 is formed having graphene sheets 110 placed over it that are atomically contiguous.

While the invention has been shown and described with reference to a particular embodiment thereof, it will be understood to those skilled in the art, that various changes in form and details may be made therein without departing from the spirit and scope of the invention.

I claim:

1. An electronic device, comprising:
a display having a viewing area; and
a hardcoat protective layer covering said display, said hardcoat protective layer comprising an atomically contiguous sheet of graphene encapsulated in a matrix and positioned over said display, said atomically contiguous sheet of graphene has a surface area at least as large as the viewing area of said display.

2. The electronic device of claim 1, wherein said atomically contiguous sheet of graphene has an area larger than the viewing area of said display.

3. The electronic device of claim 1, wherein said matrix is comprised of glass.

4. The electronic device of claim 1, wherein said matrix is comprised of a polymer or an adhesive.

5. The electronic device of claim 1, wherein said atomically contiguous sheet of graphene is comprised of a monolayer of graphene.

6. The electronic device of claim 1, wherein said atomically contiguous sheet of graphene is comprised of multiple layers of graphene.

7. The electronic device of claim 1, wherein said display is selected from the group consisting of a touch screen display, a Thin Film Transistor (TFT) display, a Liquid Crystal (LCD) display, a Ferro-Electric Liquid Display (FLD), Ferro-Liquid Crystal Displays (FLCD), a Light Emitting Diode (LED) Display, and an Organic Light Emitting Diode (OLED) Display.

8. An electronic device, comprising:
a display having a viewing area; and
a hardcoat protective layer covering said display, said hardcoat protective layer comprising an atomically contiguous sheet of graphene embedded on a surface of a matrix, said atomically contiguous sheet of graphene having an area at least as large as the viewing area of said display.

9. The electronic device of claim 8, wherein said hardcoat protective layer is flexible.

10. The electronic device of claim 8, wherein said matrix is comprised of a material selected from the group consisting of a glass, a polymer, and an adhesive.

11. The electronic device of claim 8, wherein said atomically contiguous sheet of graphene covers the entire area of the view area of said display, thereby providing wear protection to said display.

12. The electronic device of claim 8, wherein said atomically contiguous sheet of graphene is comprised of a monolayer of graphene.

13. The electronic device of claim 8, wherein said atomically contiguous sheet of graphene is comprised of multiple layers of graphene.

14. The electronic device of claim 8, wherein said display is selected from the group consisting of a touch screen display, a Thin Film Transistor (TFT) display, a Liquid Crystal (LCD) display, a Ferro-Electric Liquid Display (FLD), Ferro-Liquid Crystal Displays (FLCD), a Light Emitting Diode (LED) Display, and an Organic Light Emitting Diode (OLED) Display.

15. An electronic device, comprising:
a display having a viewing area; and
a hardcoat protective layer covering said display, said hardcoat protective layer comprising a plurality of polygonal-shaped sheets of graphene arranged in a tile-pattern to form a contiguous sheet of graphene, said contiguous sheet of graphene being on a surface of a matrix, said contiguous sheet of graphene having an area at least as large as the viewing area of said display.

16. The electronic device of claim 15, wherein said polygonal-shaped sheets of graphene are arranged in a non-overlapping tile-pattern.

17. The electronic device of claim 15, wherein said polygonal-shaped sheets of graphene are arranged in a overlapping tile-pattern.

18. The electronic device of claim 15, wherein said matrix is comprised of a material selected from the group consisting of a glass, a polymer, and an adhesive.

19. The electronic device of claim 15, wherein said contiguous sheet of graphene covers the entire area of the view area of said display, thereby providing wear protection to said display.

20. The electronic device of claim 15, wherein said display is selected from the group consisting of a touch screen display, a Thin Film Transistor (TFT) display, a Liquid Crystal (LCD) display, a Ferro-Electric Liquid Display (FLD), Ferro-Liquid Crystal Displays (FLCD), and an LED display having an array of Light Emitting Diodes (LEDs).
